(19) United States
(12) Patent Application Publication
(10) Pub. No.: US 2025/0209258 A1
(43) Pub. Date: Jun. 26, 2025

(54) METHOD AND APPARATUS FOR DISPLAYING INFORMATION OF A BOOK, ELECTRONIC DEVICE, AND COMPUTER-READABLE STORAGE MEDIUM

(71) Applicant: Beijing Zitiao Network Technology Co., Ltd., Beijing (CN)

(72) Inventors: Yuanjun YANG, Beijing (CN); Wenchang Huang, Beijing (CN); Rongqiang Huang, Beijing (CN); Guibo Pan, Beijing (CN)

(21) Appl. No.: 18/972,602

(22) Filed: Dec. 6, 2024

(30) Foreign Application Priority Data
Dec. 22, 2023 (CN) 202311791116.7

(51) Int. Cl. G06F 40/166; G06F 40/40

(52) U.S. Cl. CPC G06F 40/166; G06F 40/40

(57) ABSTRACT

The present disclosure relates to a method for displaying information of a book, an apparatus, an electronic device, and a readable storage medium, which relates to the field of computer technology. The method of the present disclosure comprises: generating a summary for each of sections of the book based on content of the each of the sections; and displaying the summary of the each of the sections in one or more distribution scenarios in a reader, in response to an operation on the book, wherein the summary of the each of the sections is displayed in different forms in different distribution scenarios.

### CROSS-REFERENCE TO RELATED APPLICATION

This application claims the priority of Chinese Application for Invention No. 202311791116.7, filed to the Patent Office of the People's Republic of China on Dec. 22, 2023, the entire content of which is incorporated herein by reference.

### TECHNICAL FIELD

The present disclosure relates to the field of computer technology, in particular to a method and apparatus for displaying information of a book, an electronic device and a computer-readable storage medium.

### BACKGROUND

With the development of Internet technology, e-books have become more and more popular among users, which has changed the reading habits of many readers.

At present, e-books can achieve a display effect similar to that of paper books. Users can enter any section they want to read from the table of contents, or browse the contents of each section in sequence.

### SUMMARY

This summary is provided for a concise introduction of the inventive concept of the present application, which will be described in detail in the Detailed Description below. This summary is not intended to identify critical features or essential features of the claimed technical solution, nor is it intended to be used to limit the scope of the claimed technical solution.

According to some embodiments of the present disclosure, there is provided a method for displaying information of a book, comprising: generating a summary for each of sections of the book based on content of the each of the sections; and displaying the summary of the each of the sections in one or more distribution scenarios in a reader, in response to an operation on the book, wherein the summary of the each of the sections is displayed in different forms in different distribution scenarios.

According to some embodiments of the present disclosure, there is provided an apparatus for displaying information of a book, comprising: a generation module configured to generate a summary for each of sections of the book based on content of the each of the sections; and a display module configured to display the summary of the each of the sections in one or more distribution scenarios in a reader, in response to an operation on the book, wherein the summary of the each of the sections is displayed in different forms in different distribution scenarios.

According to further embodiments of the present disclosure, there is provided an electronic device comprising: a memory; and a processor coupled to the memory, the processor configured to, based on instructions stored in the memory, carry out the method for displaying the information of the book according to any one of the embodiments of the present disclosure.

According to still further embodiments of the present disclosure, there is provided a non-transitory computer readable storage medium having stored thereon a computer program that, when executed by a processor, implements the method for displaying the information of the book according to any one of the embodiments of the present disclosure.

Other features and advantages of the present invention will become apparent from the following detailed description of exemplary embodiments of the present disclosure with reference to the accompanying drawings.

### BRIEF DESCRIPTION OF THE DRAWINGS

Below, preferred embodiments of this disclosure will be described with reference to the drawings. The accompanying drawings described herein are intended to provide a further understanding of the present disclosure, and together with the specific description of the drawings below, are comprised in and constitute a part of the present specification for illustration of the present disclosure. It should be understood that the drawings described below merely involve some embodiments of the present disclosure, and are not limitations of the present disclosure. In the drawings:

FIG. 1 shows a flowchart of a method for displaying information of a book according to some embodiments of the present disclosure;

FIG. 2 shows a schematic diagram of a display interface according to some embodiments of the present disclosure;

FIG. 3 shows a schematic diagram of a display interface according to other embodiments of the present disclosure;

FIG. 4 shows a schematic diagram of a display interface according to still other embodiments of the present disclosure;

FIG. 5 shows a flowchart of a method for displaying information of a book according to other embodiments of the present disclosure;

FIG. 6 shows a schematic diagram of a path map of experiences according to some embodiments of the present disclosure;

FIG. 7 shows a schematic diagram of a display interface according to still other embodiments of the present disclosure;

FIG. 8 shows a schematic diagram of an outline structure diagram according to some embodiments of the present disclosure;

FIG. 9 shows a flowchart of an apparatus for displaying information of a book according to some embodiments of the present disclosure;

FIG. 10 shows a structural diagram of an electronic device according to some embodiments of the present disclosure;

FIG. 11 shows a structural diagram of an electronic device according to other embodiments of the present disclosure.

### DETAILED DESCRIPTION

Below, a clear and complete description will be given for the technical solution of embodiments of the present disclosure with reference to the figures of the embodiments. Obviously, merely some embodiments of the present disclosure, rather than all embodiments thereof, are given herein. The description of the embodiments is merely illustrative, and in no way serves as any limitation on the present disclosure and its application or use. It should be understood that the present disclosure can be implemented in various forms and should not be construed as limited to the embodiments set forth herein.

It should be understood that the various steps described in the methods of the embodiments of the present disclosure may be executed in a different order, and/or executed in parallel. In addition, the methods may comprise additional steps and/or some of the illustrated steps may be omitted. The scope of this disclosure is not limited in this regard. Unless specifically stated otherwise, relative arrangement and values of components and steps, numerical expressions and values set forth in these embodiments are to be construed as merely illustrative, not limiting the scope of the present disclosure.

The term “comprising” and its variations used in this disclosure refer to an open-ended term that comprises at least the following elements/features, but does not exclude other elements/features, i.e. “comprising but not limited to”. In addition, the term “containing” and its variations used in this disclosure refer to an open-ended term that comprises at least the following elements/features, but does not exclude other elements/features, i.e., “containing but not limited to”. Therefore, the terms “comprising” and “containing” are synonymous. The term “based on” means “based at least in part on”.

“One embodiment”, “some embodiments” or “embodiments” used throughout the specification mean that specific features, structures or characteristics described in connection with the embodiments are comprised in at least one embodiment of the present invention. For example, the term “one embodiment” means “at least one embodiment”; the term “another embodiment” means “at least one additional embodiment”; the term “some embodiments” means “at least some embodiments”. In addition, occurrences of the phrases “in one embodiment,” “in some embodiments,” or “in embodiments” throughout this specification do not necessarily refer to the same embodiment, but may refer to the same embodiment.

It should be noted that the concepts of “first” and “second” mentioned in the present disclosure are only used to distinguish different devices, modules or units, and are not used to limit the order of functions performed by these devices, modules or units, or interdependence therebetween. Unless otherwise specified, terms such as “first” and “second” are not intended to imply that objects described in this way must be in any particular order in time, space, rank, or otherwise.

It should be noted that the modifications of “a” and “a plurality of” mentioned in the present disclosure are illustrative and not restrictive, and those skilled in the art should understand that unless clearly indicated in the context, they should be understood as “one or more”.

The names of messages or information exchanged between multiple devices in the embodiments of the present disclosure are only used for illustrative purposes, and are not used to limit the scope of these messages or information.

The following will provide a detailed explanation of the embodiments disclosed herein with reference to the accompanying drawings, but the present disclosure is not limited to these specific embodiments. The following specific embodiments can be combined with each other, and the same or similar concepts or processes may not be repeated in some embodiments. In addition, in one or more embodiments, specific features, structures or characteristics may be combined in any suitable manner, as will be apparent to those skilled in the art from this disclosure.

Currently, when an e-book is displayed, only content of each section is displayed for the e-book, and users must read the entire section to understand the content. In many cases, users may forget the content of previous sections as they read and may not be able to quickly review relevant sections.

In view of the above issues, this disclosure provides a method and apparatus for displaying information of a book, an electronic device, and a computer-readable storage medium, which can improve convenience of reading an e-book and enhance a distribution effect of the e-book.

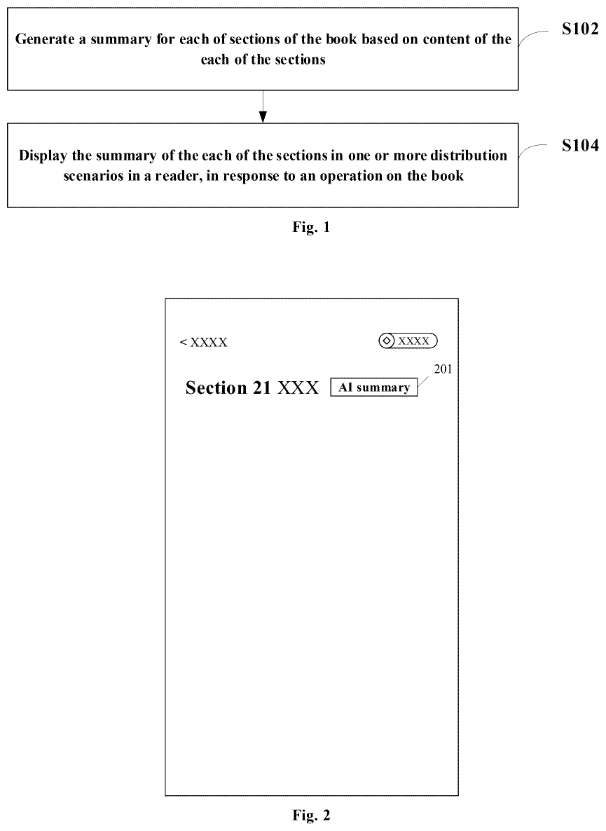

Below, some embodiments of the method for displaying information of a book of the present disclosure will be described with reference to FIGS. 1 to 8.

FIG. 1 is a flowchart of a method for displaying information of a book according to some embodiments of the present disclosure. As shown in FIG. 1, the method of this embodiment comprises: steps S102 to S104.

In step S102, a summary for each of sections of the book is generated based on content of the each of the sections.

The book is an electronic book (e-book) that can be displayed on various forms of clients, such as mobile phones, computers, tablets, etc. The summary can be generated to briefly describe the content of the each of the sections. A summary is much shorter than an entire section. For example, if a section totally contains 2000-3000 words, a summary usually contains 100-300 words, allowing it to be read quickly. When generating the summary for the each of the sections, the number of words in the summary can be specified.

In step S104, the summary of the each of the sections si displayed in one or more distribution scenarios in a reader, in response to an operation on the book, wherein the summary of the each of the sections is displayed in different forms in different distribution scenarios.

For example, the one or more distribution scenarios comprise at least one of a (distribution) scenario for displaying a reading interface for the each of the sections, or a scenario for displaying a table of contents of the book. The one or more distribution scenarios may also comprise at least one of a scenario for displaying a path map of experiences of a target role, a scenario for displaying an outline structure diagram, and a scenario for displaying information related to target key information in subsequent embodiments, but are not limited to the examples given herein. The operation on the book can also vary according to different distribution scenarios.

Different interfaces correspond to different distribution scenarios, and the summary of the each of the sections is displayed in different forms to match display effects of the interfaces, so as to improve a display effect. For example, the reading interface for the each of the sections has a relatively larger display area, so that the summary of the each of the sections can be displayed in larger fonts in the reading interface, while a display area of the each of the sections in the table of contents is smaller, so that the summary of the each of the sections can be displayed in abbreviated form and in smaller fonts in the table of contents. In the subsequent embodiments, ways of displaying the summary of the each of the sections in various distribution scenarios will be described in detail.

In the method of the above embodiment, the summary is automatically generated for the each of the sections of an e-book based on the content of the each of the sections; and in response to the operation on the e-book, the summary of the each of the sections is displayed on the reader in the one or more distribution scenarios, wherein the summary of the each of the sections is displayed in different forms in different distribution scenarios. The method of the above embodiment can enable a user to quickly and accurately understand the content of the each of the sections, thereby improving convenience of reading of the e-book and enhancing a distribution effect of the e-book. The method of the above embodiment can also enable the user to quickly locate a section he/she want to find, thereby improving an accuracy and efficiency of reading positioning. In addition, compared to the current practice in which summaries of sections are written by an author for the entire book, the method of the above embodiment automatically generates the summary for the each of the sections based on its content, thereby improving the efficiency of a generation of summaries.

In some embodiments, the generating the summary for the each of the sections of the book based on the content of the each of the sections comprises using a generative model to extract the content of the each of the sections, and generate the summary for the each of the sections of the book based on the content of the each of the sections.

An example of the generative model is the AIGC (Artificial Intelligence Generated Content) model. Through inputting content (text) of the entire book into the generative model, the content (text) of the each of the sections can be automatically extracted to generate the summary for the each of the sections. The generative model can understand and summarize the content of the each of the sections to generate the summary for the each of the sections. Training sample pairs used in a training phase of the generative model comprise text and summaries of training sections. A training section in each of the training samples may be a section that is randomly obtained. Test sample pairs used in testing comprise text and summaries of test sections. The test sample pairs can be divided into two types. The first type comprises randomly selected test sections, while the second type comprises successive test sections. The second type can test the coherence and consistency of the generated summaries, making the summaries generated by the generative model more accurate. For the specific training process, reference can be made to the existing training methods, which will not be described herein.

Ways of displaying the summary of the each of the sections in different distribution scenarios will be described below.

In some embodiments, the one or more distribution scenarios comprise a scenario of displaying a reading interface for the each of the sections, A summary control is displayed in the reading interface of a second target section on the reader, in response to a reading operation on the second target section among the sections of the book; and the summary of the second target section is displayed, in response to a trigger operation on the summary control. The operation on the book comprises a reading operation on the second target section among the sections of the book, and a trigger operation on the summary control.

The reading operation on the second target section can trigger the display of a reading interface for the second target section. For example, the reading operation can be a click on a display area of the second target section in a table of contents, or a sliding operation in a preset direction on the reading interface of a section before the second target section, which is not limited to the examples given herein.

For example, as shown in FIG. 2, a summary control 201 can be displayed next to a title of the second target section, or the summary control can be displayed in other forms at other locations, which is not limited to the examples given herein.

The summary of the second target section is displayed by triggering the summary control. The summary of the second target section can be displayed on a new page, or in a window, floating layer, panel superimposed above the reading interface, which is not limited to the examples given herein.

In some embodiments, the summary of the second target section is displayed in a panel above the reading interface of the second target section. In addition to displaying the summary of the second target section, information such as the title of the second target section can also be displayed in the panel.

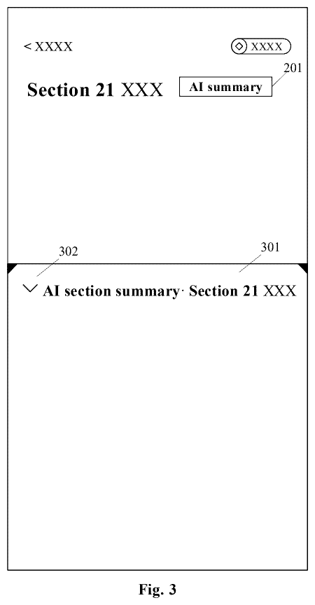

The panel can be a full-screen panel or a half-screen panel, etc. A size of the panel can be set according to the size of the reading interface and a number of words in the summary. As shown in FIG. 3, the summary may be displayed in a half-screen panel 301. The summary in the panel supports slide display. If the size of the panel is not enough to display the complete summary, a portion that is not displayed can be displayed in response to a sliding operation on the summary in a preset direction.

In some embodiments, in response to a closing operation on the summary of the second target section, the summary of the second target section is closed to display text of the second target section.

For example, the closing operation on the summary of the second target section is a trigger operation on a close control in a display interface (panel) of the summary, or a first preset operation (such as a click) within the reading interface of the second target section and outside the display interface (panel) of the summary, or a second preset operation (such as a double-click, a slide, etc.) in the summary display interface, which is not limited to the examples given herein. For example, as shown in FIG. 3, the close control 302 is displayed next to a title of the summary, and the panel can be collapsed by clicking on the close control.

In the method of the above embodiment, the summary control is displayed in the reading interface of the second target section. The trigger operation on the summary control can trigger the display of the second target section, which facilitates users to quickly understand the content of the second target section from the summary and provides convenience for reading.

In some embodiments, the one or more distribution scenarios comprise a scenario of displaying a table of contents of the book. displaying the table of contents of the book on the reader, and abbreviated information of the summary of the each of the sections is displayed in the table of contents at a location corresponding to the each of the sections, in response to a trigger operation on the table of contents of the book; the summary of a third target section is displayed, in response to a trigger operation to display the summary of the third target section among the sections. The operation on the book comprises a trigger operation on the table of contents of the book and a trigger operation to display the summary of the third target section.

A display interface of the table of contents can show contents information of the each of the sections, comprising a title, abbreviated information of the summary, as well as secondary information of the section. For example, the secondary information comprises at least one of word count, publication date, or reading progress. The reading progress can be represented in pages, but is not limited to the examples given herein. For a book divided into different volumes or subsections, contents information of the volumes or subsections can be also shown in the table of contents. The method for generating and displaying the summary of the each of the sections in this disclosure is also applicable to volumes, sections, etc., which will not be repeated here.

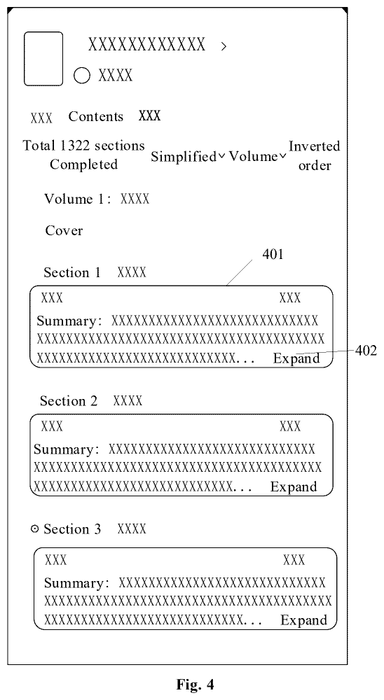

As shown in FIG. 4, the each of the sections in the table of contents has a corresponding display area 401 comprising information such as a title, abbreviated information of the summary, and secondary information, etc. Of course, the summary of the each of the sections in the table of contents can be displayed in their entirety, but the abbreviated information of the summary is preferable to prevent the summary of the each of the sections from taking up too much space. The table of contents supports slide display.

In some embodiments, the abbreviated information of the summary of the each of the sections is obtained by truncating the summary of the each of the sections; or the abbreviated information of the summary of the each of the sections is generated using a generative model based on the summary of the each of the sections.

For the summary of the each of the sections, a preset number of words can be extracted from the first word as the abbreviated information of the summary. Alternatively, a generative model can be used to refine the summary, resulting in the abbreviated information of the summary that is shorter than the original summary. This can not only reduce the size of the summary, but also improve readability.

In some embodiments, an expansion control is displayed at the location corresponding to the abbreviated information of the summary of the each of the sections, and the summary of the third target section is displayed in response to a trigger operation on the expansion control corresponding to the third target section; or the summary of the third target section is displayed, in response to a trigger operation in a display area of the abbreviated information of the summary of the third target section.

As shown in FIG. 4, an expansion control 402 can be displayed at an end of the abbreviated information of the summary of the each of the sections. By clicking on the expansion control 402, the complete summary of the third target section can be displayed. A trigger operation such as a click, a long press in the display area of the abbreviated information of the summary of the third target section can trigger the display of the complete summary.

The display area of the summary can be expanded to show the complete summary, or the summary can be displayed in a window, floating layer, or panel above the display interface of the table of contents. For example, the complete summary of the third target section can be displayed in a panel above the display interface of the table of contents.

In some embodiments, the table of contents of the book and a switch control for the table of contents are displayed, in response to the trigger operation on the table of contents of the book; the table of contents is switched between a first display state and a second display state, in response to a trigger operation on the switch control for the table of contents, wherein in the first display state, the abbreviated information of the summary of the each of the sections is displayed in the table of contents at the location corresponding to that section, and in the second display state, the abbreviated information of the summary of the each of the sections is hidden.

The table of contents can be switched between the first display state and the second display state. In the first display state, the abbreviated information of the summary of the each of the sections is displayed. In the second display state, the abbreviated information of the summary of the each of the sections is not displayed, and only a title, or a title and secondary information can be displayed.

In the method of the above embodiment, the abbreviated information of the summary of the each of the sections is displayed in the table of contents, and in response to the trigger operation to display the summary of the third target section among the sections, the summary of the third target section is displayed, thereby improving the convenience of reading the book. In addition, by displaying the summaries in the table of contents, the accuracy and efficiency of reading positioning can be improved.

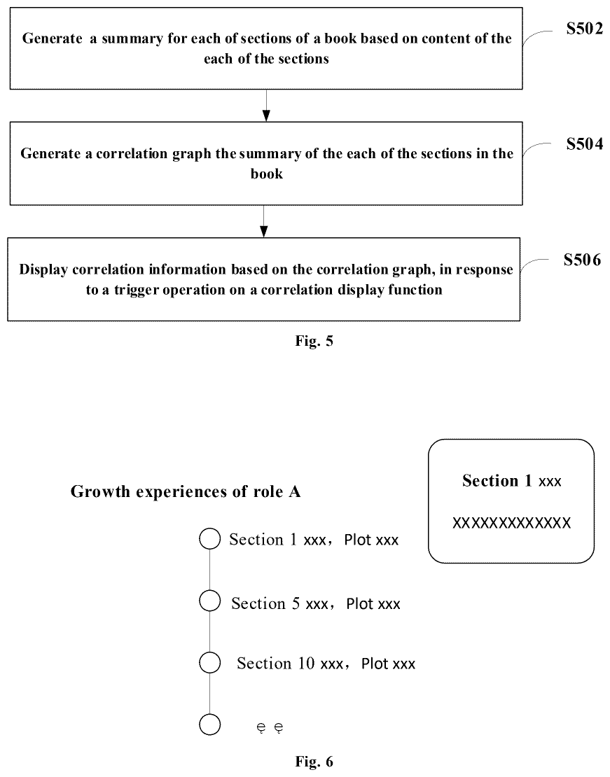

Below, other embodiments of the method for displaying information of a book of the present disclosure will be described with reference to FIG. 5.

FIG. 5 is a flowchart of a method for displaying information of a book according to other embodiments of the present disclosure. As shown in FIG. 5, the method of this embodiment comprises: steps S502 to S506.

In step S502, a summary is generated for each of sections of a book based on content of the each of the sections.

This embodiment may further comprise the step 104 in parallel with steps S504 and 506, which will not be repeated here.

In step S504, a correlation graph is generated the summary of the each of the sections in the book.

The correlation graph is used to represent relationships between key information in the sections, the key information comprising at least one of information of a role, information of a plot or information of a section. A plot is a part of a section or a summary of the section. The correlation graph can comprise multiple nodes, and each of the multiple nodes represents a role, a plot, or a section. There may be one or more correlation graphs. In some embodiments, a generative model can be used to generate the correlation graph based on the summary of the each of the sections. The method for generating the correlation graph will be described in detail in subsequent embodiments.

In step S506, correlation information is displayed based on the correlation graph, in response to a trigger operation on a correlation display function.

For example, the correlation information comprises at least one of a role(s), a plot(s) or a section(s) that are related to a specific role. A role related to the specific role can be determined based on a relationship or a change in the relationship between these two roles. The plot(s) or section(s) related to a specific role can be determined based on experience information of the specific role, or change information of a relationship between the specific role and a related role(s).

For another example, the correlation information comprises at least one of a role(s), a plot(s) or a section(s) that are related to a specific plot. The role(s) related to the specific plot can be determined based on a role(s) comprised in that plot. The plot(s) or section(s) related to the specific plot can be determined based on the experience information of a role, or change information of the a relationship between a role and a related role, or a key node(s) in story development.

For another example, the correlation information comprises at least one of a role(s), a plot(s) or a section(s) that are related to a specific section. The role(s) related to the specific section can be determined based on a role(s) comprised in that section. The plot(s) or section(s) related to the specific section can be determined based on the experience information of a role, or change information of a relationship between a role and a related role, or the story development.

Some embodiments of generating the correlation graph and displaying correlation information will be described below. Generating the correlation graph based on the summary of the each of the sections can improve the efficiency of generating the correlation graph. Of course, the correlation graph can also be directly generated based on the content of the each of the sections, which will not be described herein.

Firstly, a method for generating a correlation graph related to a role and its display method will be described.

In some embodiments, the generating the correlation graph based on the summary of the each of the sections in the book comprises: for each role, extracting experience information of the each role based on the summary of the each of the sections, wherein the experience information of the each role comprises information of a key plot experienced by the each role; based on the experience information of the each role, determining a relationship between key information, wherein the relationship between the key information comprise at least one of a relationship between information of the each role and the information of the key plot experienced by the each role, a relationship between the information of the each role and information of a section to which the key plot experienced by the each role belongs, a relationship between the information of the key plot experienced by the each role and the information of the section to which the key plot experienced by the each role belongs, or a relationship between information of multiple key plots experienced by the role; and generating the correlation graph based on the relationship between the key information.

For example, the information of the each role comprises a name, and attribute information such as identity and age of the each role; information of a plot comprises at least one of an identification, content, or summary (which can be generated using a generative model) of the plot; information of a section comprises at least one of a title, a summary, and an abbreviated summary of the section. The correlation graph can hold longer information such as summaries of the plots and summaries of the sections directly, or only hold shorter information such as identifiers of the plots and titles the sections. Content of the plots, the summaries of the sections and the abbreviated summaries of the sections can be found by means of plot identifiers and section titles.

The method of the above embodiment can be performed using a generative model. For a certain role, it is possible to identify whether the role appears in a section based on the summary of the section, extract plots experienced by the role in the sections in which it appears, and determine whether a plot experienced by the role is a key plot. For example, the key plot is a plot that affects growth, change of emotion, change of skill, or change of identity a role. In the correlation graph, edges can be set between nodes that correspond to roles, plots, and sections, and a relationship between two nodes can be indicated by setting an attribute of an edge between the two nodes. For example, an edge can be set between a node corresponding to a role and a node corresponding to a key plot experienced by the role, and an attribute of the edge can be set to represent that this key plot has the effect of causing a change of emotion of the role, as well as related information of the change of emotion. All key plots that cause the change of emotion of the role can later be identified based on the correlation graph.

In some embodiments, the generating the correlation graph based on the summary of the each of the sections in the book comprises: based on the summary of the each of the sections, determining candidate sections comprising multiple roles from the sections; determining relationships between the multiple roles in each of the candidate sections based on the summary of the each of the candidate sections; determining the relationship between the key information based on the relationships between the multiple roles in each of the candidate sections, wherein the relationship between the key information comprises a relationship between information of the multiple roles; and generating the correlation graph based on the relationship between the key information.

The method of the above embodiment can be performed using a generative model. Relationships between multiple roles can be classified into different types, comprising positive relationships such as parent-child, brother, lover, husband-wife, friend, etc., and negative relationships such as enemy and adversary, which are not limited to the examples given here. In the correlation graph, edges can be set between nodes that correspond to roles, and a relationship between two nodes can be indicated by setting an attribute of the edge between the two nodes. For example, an edge is set between nodes corresponding to role A and role B, and an attribute of the edge is set to indicate a parent-child relationship between the two nodes. Roles that are related to a given role and their relationships can later be identified based on the correlation graph.

In some embodiments, the generating the correlation graph based on the summary of the each of the sections in the book further comprises: for a role group of any multiple roles that have a relationship therebetween, determining change information of the relationship between the multiple roles in the role group and a plot where the relationship change based on a summary of a candidate section related to the role group; based on the change information of the relationship between the multiple roles in the role group and the plot where the relationship change, determining the relationship between the key information, wherein the relationship between the key information comprises at least one of a relationship between information of the multiple roles in the role group, a relationship between the information of the multiple roles in the role group and information of the plot where the relationship change, a relationship between the information of the multiple roles in the role group and information of a section to which the plot where the relationship change belongs, a relationship between information of multiple plots where the relationship between the multiple roles changes, and a relationship between information of sections to which the multiple plots where the relationship between the multiple roles changes belong; and generating the correlation graph based on the relationship between the key information.

The method based on the aforementioned embodiment can determine relationships between roles. Some relationships of the roles (such as parent-child) are fixed. Some relationships of the roles may vary, such as changing from friend to enemy, and a change in a relationship of the roles may go through several plots. Every two (or more) roles having a relationship can form a role group. For multiple roles in each role group, based on the summaries of different and related candidate sections, different relationships between the multiple roles, information of changes in relationships between the multiple roles, and information of multiple plots and sections where the relationships change can be determined. These multiple roles, plots, and sections form the correlation graph. A role group in the correlation graph can correspond to a node, and an edge can be set between this node and a node corresponding to a plot or section where a relationship between the multiple roles in the role group changes, and change information of the relationship can be set between the role group and the plot or section where the relationship changes on the edge. For example, role group 1 may comprise roles A and B. An edge is set between a node of role group 1 and plot 2, with a change of a relationship between roles A and B and their relationship being configured on the edge. Then, based on the correlation graph and the order of plots or sections, plots or sections can be identified that experience a change in relationship between multiple roles in the role group.

In some embodiments, the correlation display function comprises a correlation display function for displaying experience information of a target role, the correlation information comprising a path map of experiences of the target role.

In some embodiments, in response to the correlation display function for displaying the experience information of the target role being triggered, displaying the path map of experiences of the target role according to the correlation graph, wherein the path map of experiences comprises a plurality of nodes, each of the plurality of nodes corresponds to at least one of information of a key plot experienced by the target role or information of a section to which the key plot experienced by the target role belongs, and the information of the section to which the key plot experienced by the target role belongs comprises a summary of the section to which the key plot experienced by the target role belongs or an abbreviated summary generated based on the summary of the section to which the key plot experienced by the target role belongs.

For example, the information of the key plot experienced by the target role comprises at least one of an identification, a summary, and content of the key plot. The identification of the key plot is information that can identify the plot, such as an identification of a paragraph in a section to which the key plot belongs, a subtitle, etc. The information of the section to which the key plot experienced by the target role belongs may further comprise, for example, a title, a section number, etc. As mentioned in the previous embodiment, the relationships between roles and plots can be represented in the correlation graph. For a target role, all key plots experienced by the target role and sections to which these key plots belong can be searched, so as to generate the path map of experiences of the target role.

Experiences of a target role can be specifically classified as growth experience, emotional experience, skill change experience, identity change experience, etc. It is possible to display path maps of experiences of the target role in different categories based on operations on different controls. The key plots that correspond to nodes in different path maps of experiences have an impact on the experiences of the target role in different categories. As shown in FIG. 6, a path map corresponding to the growth experiences of role A comprises multiple nodes, each of which can illustrate information of a section and information of a plot. For example, a title of the section, an identifier of the plot, etc. can be displayed. In response to a selection of a node, a plot or a section corresponding to the node will be switched to. or in response to a selection of a node, at least one of content of a plot, a summary of the plot, a summary of a section, or an abbreviated summary of the section is displayed in a window, floating layer, or panel.

In some embodiments, the correlation display function comprises a correlation display function for displaying a role relationship view, and the correlation information comprises a role relationship view.

In some embodiments, the displaying the correlation information based on the correlation graph in response to the trigger operation on the correlation display function comprises: displaying the role relationship view in response to the correlation display function for displaying the role relationship view being triggered. The role relationship view comprises relationships between various roles in the book, information of each of the roles, and can also comprise information of plots and/or sections that correspond to establishments of the relationships between the roles, as well as information of plots and/or sections where the relationships between the roles change. For example, for roles A and B in a parent-child relationship, when role B is born, the relationship between the two roles is established.

In some embodiments, the trigger operation on the correlation display function comprises an operation on related text or a correlation display control of target key information in a first target section among the sections, the correlation information comprising information related to the target key information.

In some embodiments, the displaying the correlation information based on the correlation graph, in response to the trigger operation on the correlation display function comprises: on a reading interface of the first target section, displaying the related text of the target key information in the first target section with a preset effect or displaying the correlation display control of the target key information in the first target section according to the correlation graph, wherein the target key information comprises a target role and/or a target plot; and in response to the operation on the related text or the correlation display control of the target key information, displaying the information related to the target key information according to the correlation graph, wherein the information related to the target key information comprises at least one of information of a role related to the target key information, information of a plot related to the target key information or information of a section related to the target key information, the information of the section related to the target key information comprising a summary or an abbreviated summary generated based on the summary of the section related to the target key information.

For example, the preset display effect comprises at least one of highlighting, bold, italic, underline, different color from other text, different font size from other text, or different glyph from other text, which is not limited to the examples given herein. The related text of the target key information is displayed with a prominent effect that differs from other text. The target key information can be a target role and/or a target plot.

A correlation display control corresponding to the target key information can be displayed next to the target key information. In response to multiple pieces of target key information being displayed simultaneously on a page, each piece of target key information can have a corresponding correlation display control. It is also possible to display a correlation display control at a preset position in the reading interface. By triggering the correlation display control, information related to multiple pieces of target key information can be displayed. The display of information related to the target key information can be triggered by clicking on the related text or correlation display control of the target key information.

The information related to the target key information comprises at least one of information of a role related to the target key information, information of a plot related to the target key information or information of a section related to the target key information. For example, in response to an operation on the related text or the correlation display control of the target key information, a section or page where the information related to the target key information is located can be switched to, or the related information can be displayed in a new page, window, floating layer, or panel.

For example, if the information related to the target key information is information of a related role, a section or page where the related role first appeared or last appeared can be switched to, and text corresponding to the related role can be highlighted. Alternatively, the information of the related role can be displayed in a new page, window, floating layer, or panel to display, for example, at least one of attribute information such as the name of the related role, and the relationship between the related role and the target key information.

For example, if the information related to the target key information is information of a related plot, a section or page where the related plot locates can be switched to, and text corresponding to the related plot can be highlighted, or the information of the related plot can be displayed in a new page, window, floating layer, or panel to display, for example, at least one of an identification, content, and summary of the related plot.

For example, if the information related to the target key information is information of a related section, a related section can be switched to, or the information of the related section can be displayed in a new page, window, floating layer, or panel to display, for example, at least one of a title, content, summary and abbreviated summary of the related section.

In some embodiments, in response to the target key information comprising the target role: the first target section is a section to which a key plot experienced by the target role belongs, and the information related to the target key information comprises at least one of information of a key plot experienced by the target role before the first target section and information of a section to which a key plot experienced by the target role before the first target section belongs; and/or the first target section is a section to which a plot where a relationship between the target role and a first role who has a preset relationship with the target role changes belongs, the information related to the target key information comprising at least one of information of the first role, change information of the relationship between the target role and the first role, information of a plot where the relationship between the target role and the first role changes before the first target section, or information of a section to which the plot where the relationship between the target role and the first role belongs before the first target section changes.

A role or plot corresponding to a node in the correlation graph can serve as a target role or plot. If a role in the correlation graph appears in the first target section, it can be used as the target role, and related text of the target role can be displayed with a preset effect or a correlation display control can be displayed for the target role in the first target section. In response to a trigger operation on the related text or correlation display control of the target role, information related to the target role can be displayed.

In the correlation graph, various information can be found based on the target role, such as a key plot experienced by the target role, a section to which the key plot belongs, the relationship between the target role and a first role, information of a change in the relationship between the target role and the first role, a plot where the relationship between the target role and the first role changes, and a section to which the plot where the relationship between the target role and the first role changes belongs. Based on this information, it is possible to display information related to the target role. The first role can be one or more roles, and in the correlation graph the target role and the first role can be represented in the form of a role group.

For example, if it is determined based on the correlation graph that the first target section is a section to which a key plot experienced by the target role belongs, at least one of information of a key plot experienced by the target role (before the first target section) and information of a section to which the key plot experienced by the target role (before the first target section) belongs.

For example, if it is determined based on the correlation graph that the first target section is a section to which a plot where a relationship between the target role and a first role who has a preset relationship with the target role changes belongs, at least one of information of the first role, change information of the relationship between the target role and the first role, information of a plot where the relationship between the target role and the first role (before the first target section) changes, and information of a section to which a plot where the relationship change between the target role and the first role (before the first target section) changes belongs. The preset relationship can be any one or more relationships in the correlation graph. Information of the first role comprises its name, attribute information, relationship to the target role, etc.

For example, based on the correlation graph, if it is determined that the first target section comprises a first role that has a preset relationship with the target role, the information of the first role can be displayed.

In the above embodiment, for a given role in the book, the relationship between the role and other roles, the relationship between the role and the plots, and the relationship between the role and the sections can be extracted based on the summary of the each of the sections to generate the correlation graph. Based on the correlation graph, the roles, the plots, or the sections related to the given role can be displayed in different forms, which can improve the efficiency and accuracy of the generation of the correlation graph, thereby improving the efficiency and accuracy of the displayed correlation information, and enhancing the convenience of reading, as well as the convenience and accuracy of reading positioning.

Below, a method for generating and displaying a correlation graph related to a plot will be described. How to correlate plots or sections based on the experience of a role or a change in the relationship between multiple roles in a role group has been described in the above embodiment, which will not be repeated here.

In some embodiments, the generating the correlation graph based on the summary of the each of the sections in the book comprises: based on the summary of each of the sections, determining logical information of a story of the book, wherein the logical information of the story comprises at least one of plot information of multiple key nodes in the story development and information of multiple plots with directional relationships; based on the logical information of the story, determining the relationship between the key information, wherein in response to the logical information of the story comprising information of plots of multiple key nodes in story development, the relationship between the key information comprises at least one of a relationship between the information of the plots of the multiple key nodes or a relationship between information of sections to which the plots of multiple key nodes belong; in the case where the logical information of the story comprising information of multiple plots with directional relationships, the relationship between the key information comprises at least one of a relationship between information of the multiple plots with directional relationships or a relationship between information of sections to which the multiple plots with directional relationships belong; and generating the correlation graph of the sections based on the relationship between the key information.

Not every section or plot in the book is a key node that affects the development of the story. Some plots are intended to enrich content of the story and are not important for the development of the story. Therefore, plots and/or sections of the key nodes in the development of the story can be extracted. For example, the multiple plots with directional relationships may comprise previous plots recalled in one scenario, or previous plots mentioned by a role when speaking, etc., which are not limited to the examples given herein.

The above method for generating the correlation graph can be performed using a generative model. Different plots in the generated correlation graph can correspond to different nodes, and edges between nodes corresponding to multiple plots with directional relationships can have direction settings indicating the directional relationships. Edges can be set for the nodes corresponding to key nodes in the development of the story in a plot order, and attributes of the edges can be set to represent the relationships between the plots as a relationship representing the development of the story.

In some embodiments, the displaying the correlation information based on the correlation graph, in response to the trigger operation on the correlation display function comprises: on a reading interface of the first target section, displaying the related text of the target key information in the first target section with a preset effect or displaying the correlation display control of the target key information in the first target section according to the correlation graph, wherein the target key information comprises a target role and/or a target plot; and in response to the operation on the related text or the correlation display control of the target key information, displaying the information related to the target key information according to the correlation graph, wherein the information related to the target key information comprises at least one of information of a role related to the target key information, information of a plot related to the target key information or information of a section related to the target key information, the information of the section related to the target key information comprising a summary or an abbreviated summary generated based on the summary of the section related to the target key information.

In some embodiments, in response to the target key information comprising the target plot:
the information related to the target key information comprises at least one of information of a plot pointed to by the target plot or information of a section to which the plot pointed to by the target plot belongs; or
the target plot is a key plot experienced by a preset role, the information related to the target key information comprising at least one of information of one or more key plots experienced by the preset role before the target plot, or information of a section(s) to which the one or more key plots experienced by the preset role before the target plot belong; or
the target plot is a plot where a relationship between the preset role and a second role who has a preset relationship with the preset role changes, and the information related to the target key information comprises at least one of information of a plot where the relationship between the preset role and the second role changes before the target plot, or information of a section to which the plot where the relationship between the preset role and the second role changes before the target plot belongs; or
the target plot is a plot of a key node in story development, and the information related to the target key information comprises at least one of information of plots of multiple key nodes in the story development, information of sections to which the plots of the multiple key nodes in the story development belong, or a logical rel.

In the correlation graph, it is possible to search for information such as a plot or section that a target plot points to; key plots comprising the target plot which a same role experiences and sections to which the key plots belong; it is possible to search for plots where a relationship between roles in a role group changes and sections to which the plots belong and the plots comprises the target plot; and it is possible to search for plots of key nodes comprising the target plot in the development of the story and sections to which the plots belong. Based on this information, it is possible to display information related to the target plot.

For example, at least one of information of a plot pointed to by the target plot or information of a section to which the plot pointed to by the target plot belongs is displayed based on the correlation graph. The information of the plot pointed to by the target plot may comprise at least one of content, a summary, or an identification; and the information of the section to which the plot pointed to by the target plot belongs may comprise at least one of content, a summary, an abbreviated summary, or a title. As mentioned in the above embodiments, it is possible to switch to the plot or the section pointed to by the target plot, and to display information of the plot pointed to by the target plot and the section it belongs to on a new page, window, floating layer, or panel.

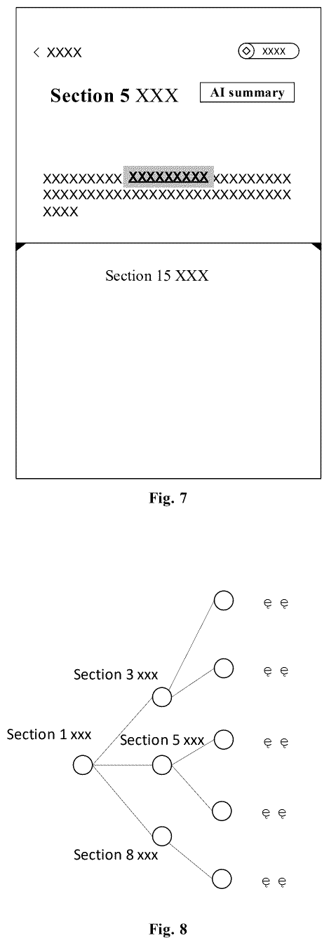

As shown in FIG. 7, the text of the target plot is displayed with a prominent effect. In response to an operation on the text of the target plot, information of a section to which a plot pointed to by the target plot belongs is displayed in a half-screen panel. For example, a summary, abbreviated summary, or content of the section to which the plot pointed to by the target plot belongs can be displayed.

It is also possible to display information of related roles based on the target plot. Reference can be made to the display of related roles based on a given role or the display of related plots based on a given role mentioned above, which will not be repeated here.

In the above embodiment, for a given plot in the book, the relationships of the plot to other plots, roles, and sections can be extracted based on the summary of the each of the sections to generate the correlation graph. Based on the correlation graph, the plots or the sections related to the given plot can be displayed in different forms, which can improve the efficiency and accuracy of correlation graph generation, thereby improving the efficiency and accuracy of the displayed correlation information, and enhancing the convenience of reading, as well as the convenience and accuracy of reading positioning.

Below, a generating method and a display method for a correlation graph related to a section will be described. How to correlate sections based on the experience of a role or a change in the relationship between multiple roles in a role group has been described in the above embodiment, which will not be repeated here.

In some embodiments, an outline of the book is determined based on a summary of each of the sections, wherein the outline comprises information of multiple sections and relationships between the information of the multiple sections. Based on the outline, relationships between key information are determined, wherein the relationships between the key information constitute the relationships between the information of the multiple sections in the outline. Based on the relationships between the key information, the correlation graph between the sections is generated.

The book may comprise a plurality of storylines, different storylines corresponding to different plots, sections, etc., and forming different levels according to a development of the story. Therefore, the multiple sections in the outline can form different levels, and form multi-level nodes in the correlation graph. In the correlation graph, attributes can be set for nodes corresponding to sections at different levels to represent a hierarchy of sections, and edges can be set between nodes corresponding to related sections.

In some embodiments, the correlation information comprises an outline structure diagram of the book.

In some embodiments, the displaying the correlation information based on the correlation graph, in response to the trigger operation on the correlation display function comprises: in response to the trigger operation on the correlation display function, displaying the outline structure diagram according to the correlation graph, wherein the outline structure diagram comprises multiple levels of nodes determined according to story development logic of the book, nodes in each level of the multiple levels corresponding to information of multiple plots and/or information of multiple sections, and the information of the multiple sections comprising summaries of the multiple sections or abbreviated summaries of the multiple sections generated based on the summaries of the multiple sections.

According to the correlation graph, the sections related with each other and levels of the sections can be determined, thus forming the outline structure diagram.

As shown in FIG. 8, the outline structure diagram comprises multiple levels of nodes, each level of nodes corresponding to multiple sections, which is not limited to the two-level structure shown in the figure and may comprise more than two levels. Each node displays information of a corresponding section. In addition, information of plots of key nodes in the development of the story can also be displayed. The information of a section comprises a title, summary, and abbreviated summary of the section. It is possible to display only titles and/or abbreviated summaries of sections in the outline structure diagram. In response to an operation on a target node, the summary of a section corresponding to the target node is displayed or a section corresponding to the target node is switched to.

According to the correlation graph, information of roles, plots, and/or sections related to a first target section can also be displayed. For example, a section correlation display control is displayed in the reading interface of the first target section. In response to a trigger operation on the section correlation display control, the information of roles, plots, and/or sections related to the first target section is displayed. For the display details, reference can be made to the foregoing embodiments, which will not be repeated herein.

In the above embodiment, for a given section in the book, the relationships of this section to roles, plots, and other sections can be extracted based on the summary of the each of the sections to generate the correlation graph, and the outline structure diagram can be displayed in different forms based on the correlation graph to display the roles, plots, or sections related to the given section, which can improve the efficiency and accuracy of the generation of the correlation graph, thereby improving the efficiency and accuracy of the displayed correlation information, and enhancing the convenience of reading, as well as the convenience and accuracy of reading positioning.

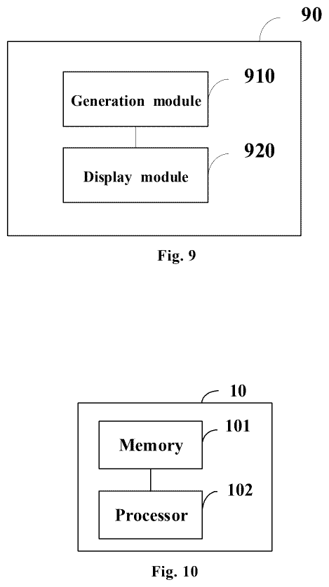

The present disclosure also provides an apparatus for displaying information of a book, which will be described below with reference to FIG. 9.

FIG. 9 is a block diagram of an apparatus for displaying information of a book according to some embodiments of the present disclosure. As shown in FIG. 9, the apparatus 90 of this embodiment comprises: a generation module 910 and a display module 920.

The generation module 910 is configured to generate a summary for each of sections of the book based on content of the each of the sections; and

the display module 920 is configured to display the summary of the each of the sections in one or more distribution scenarios in a reader, in response to an operation on the book, wherein the summary of the each of the sections is displayed in different forms in different distribution scenarios.

In some embodiments, the generation module 910 is configured to use a generative model to extract the content of the each of the sections, and generate the summary for the each of the sections of the book based on the content of the each of the sections.

In some embodiments, the generation module 910 is further configured to generate a correlation graph based on the summary of the each of the sections in the book, wherein the correlation graph is used to represent relationships between key information in the sections, the key information comprising at least one of information of a role, information of a plot or information of a section; and the display module 920 is further configured to display correlation information based on the correlation graph, in response to a trigger operation on a correlation display function.

In some embodiments, the correlation display function comprises a correlation display function for displaying experience information of a target role, the correlation information comprising a path map of experiences of the target role, and the display module 920 is configured to, in response to the correlation display function for displaying the experience information of the target role being triggered, display the path map of experiences of the target role according to the correlation graph, wherein the path map of experiences comprises a plurality of nodes, each of the plurality of nodes corresponds to at least one of information of a key plot experienced by the target role or information of a section to which the key plot experienced by the target role belongs, and the information of the section to which the key plot experienced by the target role belongs comprises a summary of the section to which the key plot experienced by the target role belongs or an abbreviated summary generated based on the summary of the section to which the key plot experienced by the target role belongs.

In some embodiments, the correlation information comprises an outline structure diagram of the book, and the display module 920 is configured to, in response to the trigger operation on the correlation display function, display the outline structure diagram according to the correlation graph, wherein the outline structure diagram comprises multiple levels of nodes determined according to story development logic of the book, nodes in each level of the multiple levels corresponding to information of multiple plots and/or information of multiple sections, and the information of the multiple sections comprising summaries of the multiple sections or abbreviated summaries of the multiple sections generated based on the summaries of the multiple sections.

In some embodiments, the trigger operation on the correlation display function comprises an operation on related text or a correlation display control of target key information in a first target section among the sections, the correlation information comprising information related to the target key information. The display module 920 is configured to, on a reading interface of the first target section, display the related text of the target key information in the first target section with a preset effect or displaying the correlation display control of the target key information in the first target section according to the correlation graph, wherein the target key information comprises a target role and/or a target plot; and in response to the operation on the related text or the correlation display control of the target key information, display the information related to the target key information according to the correlation graph, wherein the information related to the target key information comprises at least one of information of a role related to the target key information, information of a plot related to the target key information or information of a section related to the target key information, the information of the section related to the target key information comprising a summary or an abbreviated summary generated based on the summary of the section related to the target key information.

In some embodiments, response to the target key information comprising the target role: the first target section is a section to which a key plot experienced by the target role belongs, and the information related to the target key information comprises at least one of information of a key plot experienced by the target role before the first target section and information of a section to which a key plot experienced by the target role before the first target section belongs; and/or the first target section is a section to which a plot where a relationship between the target role and a first role who has a preset relationship with the target role changes belongs, the information related to the target key information comprising at least one of information of the first role, change information of the relationship between the target role and the first role, information of a plot where the relationship between the target role and the first role changes before the first target section, or information of a section to which the plot where the relationship between the target role and the first role belongs before the first target section changes.

In some embodiments, response to the target key information comprising the target plot: the information related to the target key information comprises at least one of information of a plot pointed to by the target plot or information of a section to which the plot pointed to by the target plot belongs; or the target plot is a key plot experienced by a preset role, the information related to the target key information comprising at least one of information of one or more key plots experienced by the preset role before the target plot, or information of a section(s) to which the one or more key plots experienced by the preset role before the target plot belong; or the target plot is a plot where a relationship between the preset role and a second role who has a preset relationship with the preset role changes, and the information related to the target key information comprises at least one of information of a plot where the relationship between the preset role and the second role changes before the target plot, or information of a section to which the plot where the relationship between the preset role and the second role changes before the target plot belongs; or the target plot is a plot of a key node in story development, and the information related to the target key information comprises at least one of information of plots of multiple key nodes in the story development, information of sections to which the plots of the multiple key nodes in the story development belong, or a logical relationship between the multiple key nodes in the story development.

In some embodiments, the generation module 910 is configured to, for each role, extract experience information of the each role based on the summary of the each of the sections, wherein the experience information of the each role comprises information of a key plot experienced by the each role, based on the experience information of the each role, determining a relationship between key information, wherein the relationship between the key information comprise at least one of a relationship between information of the each role and the information of the key plot experienced by the each role, a relationship between the information of the each role and information of a section to which the key plot experienced by the each role belongs, a relationship between the information of the key plot experienced by the each role and the information of the section to which the key plot experienced by the each role belongs, or a relationship between information of multiple key plots experienced by the role; and generate the correlation graph based on the relationship between the key information.

In some embodiments, the generation module 910 is configured to, based on the summary of the each of the sections, determine candidate sections comprising multiple roles from the sections; determine relationships between the multiple roles in each of the candidate sections based on the summary of the each of the candidate sections; determine the relationship between the key information based on the relationships between the multiple roles in each of the candidate sections, wherein the relationship between the key information comprises a relationship between information of the multiple roles; and generate the correlation graph based on the relationship between the key information.

In some embodiments, the generation module 910 is configured to, for a role group of any multiple roles that have a relationship therebetween, determine change information of the relationship between the multiple roles in the role group and a plot where the relationship change based on a summary of a candidate section related to the role group; based on the change information of the relationship between the multiple roles in the role group and the plot where the relationship change, determine the relationship between the key information, wherein the relationship between the key information comprises at least one of a relationship between information of the multiple roles in the role group, a relationship between the information of the multiple roles in the role group and information of the plot where the relationship change, a relationship between the information of the multiple roles in the role group and information of a section to which the plot where the relationship change belongs, a relationship between information of multiple plots where the relationship between the multiple roles changes, and a relationship between information of sections to which the multiple plots where the relationship between the multiple roles changes belong; and generate the correlation graph based on the relationship between the key information.

In some embodiments, the generation module 910 is configured to, based on the summary of each of the sections, determine logical information of a story of the book, wherein the logical information of the story comprises at least one of plot information of multiple key nodes in the story development and information of multiple plots with directional relationships; based on the logical information of the story, determine the relationship between the key information, wherein in response to the logical information of the story comprising information of plots of multiple key nodes in story development, the relationship between the key information comprises at least one of a relationship between the information of the plots of the multiple key nodes or a relationship between information of sections to which the plots of multiple key nodes belong; in the case where the logical information of the story comprising information of multiple plots with directional relationships, the relationship between the key information comprises at least one of a relationship between information of the multiple plots with directional relationships or a relationship between information of sections to which the multiple plots with directional relationships belong; and generate the correlation graph of the sections based on the relationship between the key information.

In some embodiments, the one or more distribution scenarios comprise a scenario for displaying a reading interface for a section, and the display module 920 is configured to display a summary control in the reading interface of a second target section on the reader, in response to a reading operation on the second target section among the sections of the book; and display the summary of the second target section, in response to a trigger operation on the summary control.

In some embodiments, the display module 920 is configured to display the summary of the second target section in a panel above the reading interface of the second target section.

In some embodiments, the display module 920 is configured to close the summary of the second target section and displaying text of the second target section, in response to a closing operation on the summary of the second target section.

In some embodiments, the one or more distribution scenarios comprise a scenario for displaying a table of contents of a book, and the display module 920 is configured to display the table of contents of the book on the reader, and display abbreviated information of the summary of the each of the sections in the table of contents at a location corresponding to the each of the sections, in response to a trigger operation on the table of contents of the book; and display the summary of a third target section, in response to a trigger operation to display the summary of the third target section among the sections.

In some embodiments, the abbreviated information of the summary of the each of the sections is obtained by truncating the summary of the each of the sections; or the abbreviated information of the summary of the each of the sections is generated using a generative model based on the summary of the each of the sections.

In some embodiments, the display module 920 is configured to display the table of contents of the book and displaying a switch control for the table of contents, in response to the trigger operation on the table of contents of the book; switch the table of contents between a first display state and a second display state, in response to a trigger operation on the switch control for the table of contents, wherein in the first display state, the abbreviated information of the summary of the each of the sections is displayed in the table of contents at the location corresponding to that section, and in the second display state, the abbreviated information of the summary of the each of the sections is hidden.

In some embodiments, the display module 920 is configured to display an expansion control at the location corresponding to the abbreviated information of the summary of the each of the sections, and display the summary of the third target section in response to a trigger operation on the expansion control corresponding to the third target section; or display the summary of the third target section, in response to a trigger operation in a display area of the abbreviated information of the summary of the third target section.

It should be noted that the above modules are only logical modules divided according to their specific functions, and are not intended to limit the specific embodiments, and can be implemented in software, hardware, or a combination of software and hardware. In practical implementation, the above modules may be implemented as independent physical entities, or may also be implemented by a single entity (such as a processor (CPU or DSP, etc.), integrated circuit, etc.). In addition, the above modules indicated by dashed lines in the accompanying drawings may not actually exist, and the operations/functions they implement can be implemented by processing circuitry itself.

In addition, although not shown, the device may also comprise a memory that can store various information generated by the device or various modules contained in the device during operation, programs and data used for operation, data to be sent by a communication module, and so on. The memory may be volatile memory and/or non-volatile memory. For example, the memory may comprise, but is not limited to, random access memory (RAM), dynamic random access memory (DRAM), static random access memory (SRAM), read-only memory (ROM), and flash memory. Of course, the memory may also be located outside of the device. Optionally, although not shown, the device may also comprise a communication module that can be used to communicate with other devices. In an example, the communication module may be implemented in any suitable manner known in the art, comprising communication components such as antenna arrays and/or RF links, various types of interfaces, communication modules, and so forth, which will not be described in detail herein. In addition, the device may also comprise other components not shown, such as RF links, baseband processing modules, network interfaces, processors, controllers, etc, which will not be described in detail herein.

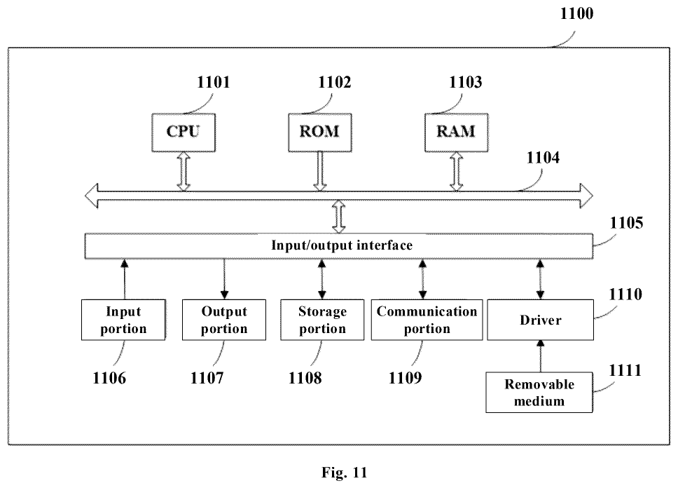

Some embodiments of the present disclosure further provide an electronic device. FIG. 10 shows a block diagram of an electronic device according to some embodiments of the present disclosure. For example, in some embodiments, the electronic device 10 may be any type of device, such as, but not limited to, a mobile terminal such as a mobile phone, a laptop, a digital broadcast receiver, a PDA (personal digital assistant), a PAD (tablet computer), a PMP (portable multimedia player), a vehicle terminal (such as vehicle navigation terminal), or a fixed terminal such as a digital TV, a desktop computer, etc. For example, the electronic device 10 may comprise a display panel for displaying data utilized in accordance with the disclosed scheme and/or execution results. For example, the display panel can have various shapes. For example, it can be a rectangular panel, an elliptical panel, or a polygonal panel. Furthermore, the display can be not only flat, but curved or even spherical.

As shown in FIG. 10, the electronic device 10 of this embodiment comprises: a memory 101 and a processor 102 coupled to the memory 101. It should be noted that the components of the electronic device 100 shown in FIG. 10 are only exemplary and not limiting. Depending on the actual application requirements, the electronic device 100 may have other components. The processor 102 can control other components in the electronic device 10 to perform desired functions.

In some embodiments, the memory 101 is used to store one or more computer-readable instructions. When the processor 102 is used to run the computer-readable instructions, the computer-readable instructions are executed by processor 102 to implement the method described in any of the above embodiments. The specific implementation of each step of the method and related explanations can be found in the above embodiments, and will not be repeated here.

For example, the processor 102 and the memory 101 can communicate with each other directly or indirectly. For example, the processor 102 and the memory 101 can communicate through a network. The network can be a wireless network, a wired network, and/or any combination of wireless and wired networks. The processor 102 and the memory 101 can also communicate with each other through a system bus, which is not limited in this disclosure.

For example, the processor 102 may be embodied as various suitable processors, processing devices, etc., such as a central processing unit (CPU), a graphics processing unit (GPU), a network processor (NP), etc; It may also be a digital signal processor (DSP), application specific integrated circuit (ASIC), field programmable gate array (FPGA) or other programmable logic device, discrete gate or transistor logic device, or discrete hardware component. The central processing unit (CPU) can be X106 or ARM architecture, etc. For example, the memory 101 may comprise any combination of various forms of computer-readable storage media, such as volatile memory and/or non-volatile memory. The memory 101 may comprise system memory, which stores, for example, an operating system, applications, a boot loader, databases, and other programs. Various applications and data can also be stored in the storage media.

In addition, according to some embodiments of the present disclosure, in the case where various operations/processes according to the present disclosure are implemented by software and/or firmware, programs constituting the software can be installed from a storage medium or network to a computer system with a dedicated hardware structure, such as the computer system 1100 shown in FIG. 11. The computer system with the various programs installed can perform various functions, comprising functions such as those described above. FIG. 11 is a block diagram illustrating an example structure of a computer system that can be used in accordance with embodiments of the present disclosure.

In FIG. 11, the central processing unit (CPU) 1101 executes various processes based on programs stored in the read-only memory (ROM) 1102 or programs loaded from the storage 1108 to the random access memory (RAM) 1103. Data required by the CPU 1101 to perform various processes are also stored in the RAM 1103 as needed. The central processing unit is only an example and can also be other types of processors, such as the various processors mentioned above. The ROM 1102, RAM 1103, and storage 1108 can be various forms of computer-readable storage media, as described below. It should be noted that although the ROM 1102, RAM 1103, and storage device 1108 are shown separately in FIG. 11, one or more of them may be combined or located in the same or different memory or storage modules.

The CPU 1101, ROM 1102, and RAM 1103 are connected to one another via a bus 1104. An input/output (I/O) interface 1105 is also connected to the bus 1104.

The following components are connected to the input/output interface 1105: an input portion 606 comprising, for example, a touch screen, a touch pad, a keyboard, a mouse, an image sensor, a microphone, an accelerometer, a gyroscope, etc; an output portion 1107, comprising a display such as a cathode ray tube (CRT), a liquid crystal display (LCD), a speaker, a vibrator, etc; a storage portion 1108, comprising a hard drive, a magnetic tape, etc; and a communication portion 1109, comprising a network interface card such as a LAN card, a modem, etc. The communication portion 1109 allows communication processing to be performed via a network such as the Internet. It is easy to understand that although the various devices or modules in the electronic device 1100 are shown in FIG. 11 as communicating through the bus 1104, they can also communicate through a network or other means, where the network can comprise a wireless network, a wired network, and/or any combination of wireless and wired networks.

A driver 1110 is also connected to input/output interface 1105 as needed. A removable medium 1111 such as a magnetic disk, an optical disk, a magneto-optical disk, a semiconductor storage device, etc. is placed in the drive 1110 as needed, so that computer programs read from the medium can be installed into storage portion 1108 as needed.

When the above processes are implemented by software, the programs that make up the software can be installed from a network, such as the Internet, or from a storage medium, such as the removable storage medium 1111.

According to an embodiment of the present disclosure, the processes described above with reference to the flowchart can be implemented as a computer software program. For example, some embodiments of the present disclosure comprise a computer program product comprising a computer program carried on a computer-readable medium, the computer program containing program code for performing the method illustrated in the flowcharts. In such an embodiment, the computer program may be downloaded and installed from the network through the communication device 1109, or installed from the storage device 1108, or from the ROM 1102. When the computer program is executed by the CPU 1101, the above functions defined in the method of the embodiment of the present disclosure are performed.

It should be noted that, in the context of the present disclosure, a computer-readable medium may be a tangible medium, which may contain or store a program for use by or in connection with an instruction execution system, apparatus, or device. The computer readable medium may be a computer readable signal medium or a computer readable storage medium, or any combination of thereof. The computer readable storage medium may be, but is not limited to: an electronic, magnetic, optical, electromagnetic, infrared, or semiconductor system, apparatus, or device, or any combination of the above. More specific examples of the computer readable storage medium may comprise, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, a computer readable storage medium can be any tangible medium that can contain or store a program, which can be used by or in connection with an instruction execution system, apparatus or device. In the present disclosure, a computer readable signal medium may comprise a data signal that is propagated in the baseband or as part of a carrier, carrying computer readable program code. Such propagated data signals can take a variety of forms comprising, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, comprising but not limited to wire, fiber optic cable, RF (radio frequency), etc., or any suitable combination of the foregoing.

The above computer readable medium may be comprised in the electronic device described above; or it may exist alone without being assembled into the electronic device.

In some embodiments, there is further provided a computer program, comprising: instructions that, when executed by a processor, cause the processor to perform the method of any one of the above embodiments. For example, the instructions can be embodied as computer program code.

In embodiments of the present disclosure, computer program code for executing operations of the present disclosure may be complied by any combination of one or more program design languages, the program design languages comprising, but not limited to, object-oriented program design languages, such as Java, Smalltalk, C++, etc, as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the latter circumstance, the remote computer may be connected to the user computer through various kinds of networks, comprising local area network (LAN) or wide area network (WAN), or connected to external computer (for example using an Internet service provider via Internet).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. It should also be noted that, in some alternative implementations, the functions noted in the block may occur out of the order noted in the drawings. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The modules, components or units involved in the embodiments described in the present disclosure can be implemented by software or hardware. Wherein, the names of the modules, components or units do not constitute a limitation on the modules, components or units themselves under certain circumstances.

The functions described above may be performed at least in part by one or more hardware logic components. For example, without limitation, exemplary types of hardware logic components that can be used comprise: Field Programmable Gate Array (FPGA), Application Specific Integrated Circuit (ASIC), Application Specific Standard Product (ASSP), System on Chip (SOC), Complex Programmable Logic Device (CPLD), etc.

According to some embodiments of the present disclosure, there is provided a method for displaying information of a book, comprising: generating a summary for each of sections of the book based on content of the each of the sections; and displaying the summary of the each of the sections in one or more distribution scenarios in a reader, in response to an operation on the book, wherein the summary of the each of the sections is displayed in different forms in different distribution scenarios.

In some embodiments, the generating the summary for the each of the sections of the book based on the content of the each of the sections comprises: using a generative model to extract the content of the each of the sections, and generate the summary for the each of the sections of the book based on the content of the each of the sections.

In some embodiments, the method further comprises: generating a correlation graph based on the summary of the each of the sections in the book, wherein the correlation graph is used to represent relationships between key information in the sections, the key information comprising at least one of information of a role, information of a plot or information of a section; and displaying correlation information based on the correlation graph, in response to a trigger operation on a correlation display function.

In some embodiments, the correlation display function comprises a correlation display function for displaying experience information of a target role, the correlation information comprising a path map of experiences of the target role, and the displaying the correlation information based on the correlation graph, in response to the trigger operation on the correlation display function comprises: in response to the correlation display function for displaying the experience information of the target role being triggered, displaying the path map of experiences of the target role according to the correlation graph, wherein the path map of experiences comprises a plurality of nodes, each of the plurality of nodes corresponds to at least one of information of a key plot experienced by the target role or information of a section to which the key plot experienced by the target role belongs, and the information of the section to which the key plot experienced by the target role belongs comprises a summary of the section to which the key plot experienced by the target role belongs or an abbreviated summary generated based on the summary of the section to which the key plot experienced by the target role belongs.

In some embodiments, wherein the correlation information comprises an outline structure diagram of the book, and the displaying the correlation information based on the correlation graph, in response to the trigger operation on the correlation display function comprises: in response to the trigger operation on the correlation display function, displaying the outline structure diagram according to the correlation graph, wherein the outline structure diagram comprises multiple levels of nodes determined according to story development logic of the book, nodes in each level of the multiple levels corresponding to information of multiple plots and/or information of multiple sections, and the information of the multiple sections comprising summaries of the multiple sections or abbreviated summaries of the multiple sections generated based on the summaries of the multiple sections.

In some embodiments, the trigger operation on the correlation display function comprises an operation on related text or a correlation display control of target key information in a first target section among the sections, the correlation information comprising information related to the target key information, and the displaying the correlation information based on the correlation graph, in response to the trigger operation on the correlation display function comprises: on a reading interface of the first target section, displaying the related text of the target key information in the first target section with a preset effect or displaying the correlation display control of the target key information in the first target section according to the correlation graph, wherein the target key information comprises a target role and/or a target plot; and in response to the operation on the related text or the correlation display control of the target key information, displaying the information related to the target key information according to the correlation graph, wherein the information related to the target key information comprises at least one of information of a role related to the target key information, information of a plot related to the target key information or information of a section related to the target key information, the information of the section related to the target key information comprising a summary or an abbreviated summary generated based on the summary of the section related to the target key information.

In some embodiments, response to the target key information comprising the target role: the first target section is a section to which a key plot experienced by the target role belongs, and the information related to the target key information comprises at least one of information of a key plot experienced by the target role before the first target section and information of a section to which a key plot experienced by the target role before the first target section belongs; and/or the first target section is a section to which a plot where a relationship between the target role and a first role who has a preset relationship with the target role changes belongs, the information related to the target key information comprising at least one of information of the first role, change information of the relationship between the target role and the first role, information of a plot where the relationship between the target role and the first role changes before the first target section, or information of a section to which the plot where the relationship between the target role and the first role belongs before the first target section changes.

In some embodiments, response to the target key information comprising the target plot: the information related to the target key information comprises at least one of information of a plot pointed to by the target plot or information of a section to which the plot pointed to by the target plot belongs; or the target plot is a key plot experienced by a preset role, the information related to the target key information comprising at least one of information of one or more key plots experienced by the preset role before the target plot, or information of a section(s) to which the one or more key plots experienced by the preset role before the target plot belong; or the target plot is a plot where a relationship between the preset role and a second role who has a preset relationship with the preset role changes, and the information related to the target key information comprises at least one of information of a plot where the relationship between the preset role and the second role changes before the target plot, or information of a section to which the plot where the relationship between the preset role and the second role changes before the target plot belongs; or the target plot is a plot of a key node in story development, and the information related to the target key information comprises at least one of information of plots of multiple key nodes in the story development, information of sections to which the plots of the multiple key nodes in the story development belong, or a logical relationship between the multiple key nodes in the story development.

In some embodiments, generating the correlation graph based on the summary of the each of the sections in the book comprises: for each role, extracting experience information of the each role based on the summary of the each of the sections, wherein the experience information of the each role comprises information of a key plot experienced by the each role; based on the experience information of the each role, determining a relationship between key information, wherein the relationship between the key information comprise at least one of a relationship between information of the each role and the information of the key plot experienced by the each role, a relationship between the information of the each role and information of a section to which the key plot experienced by the each role belongs, a relationship between the information of the key plot experienced by the each role and the information of the section to which the key plot experienced by the each role belongs, or a relationship between information of multiple key plots experienced by the role; generating the correlation graph based on the relationship between the key information.

In some embodiments, generating the correlation graph based on the summary of the each of the sections in the book comprises: based on the summary of the each of the sections, determining candidate sections comprising multiple roles from the sections; determining relationships between the multiple roles in each of the candidate sections based on the summary of the each of the candidate sections; determining the relationship between the key information based on the relationships between the multiple roles in each of the candidate sections, wherein the relationship between the key information comprises a relationship between information of the multiple roles; and generating the correlation graph based on the relationship between the key information.

In some embodiments, the generating the correlation graph based on the summary of the each of the sections in the book further comprises: for a role group of any multiple roles that have a relationship therebetween, determining change information of the relationship between the multiple roles in the role group and a plot where the relationship change based on a summary of a candidate section related to the role group; based on the change information of the relationship between the multiple roles in the role group and the plot where the relationship change, determining the relationship between the key information, wherein the relationship between the key information comprises at least one of a relationship between information of the multiple roles in the role group, a relationship between the information of the multiple roles in the role group and information of the plot where the relationship change, a relationship between the information of the multiple roles in the role group and information of a section to which the plot where the relationship change belongs, a relationship between information of multiple plots where the relationship between the multiple roles changes, and a relationship between information of sections to which the multiple plots where the relationship between the multiple roles changes belong; generating the correlation graph based on the relationship between the key information.

In some embodiments, generating the correlation graph based on the summary of the each of the sections in the book comprises: based on the summary of each of the sections, determining logical information of a story of the book, wherein the logical information of the story comprises at least one of plot information of multiple key nodes in the story development and information of multiple plots with directional relationships; based on the logical information of the story, determining the relationship between the key information, wherein in response to the logical information of the story comprising information of plots of multiple key nodes in story development, the relationship between the key information comprises at least one of a relationship between the information of the plots of the multiple key nodes or a relationship between information of sections to which the plots of multiple key nodes belong; in the case where the logical information of the story comprising information of multiple plots with directional relationships, the relationship between the key information comprises at least one of a relationship between information of the multiple plots with directional relationships or a relationship between information of sections to which the multiple plots with directional relationships belong; generating the correlation graph of the sections based on the relationship between the key information.

In some embodiments, the one or more distribution scenarios comprise a scenario of displaying a reading interface for the each of the sections, and the displaying the summary of the each of the sections in the one or more distribution scenarios in the reader, in response to the operation on the book comprises: displaying a summary control in the reading interface of a second target section on the reader, in response to a reading operation on the second target section among the sections of the book; displaying the summary of the second target section, in response to a trigger operation on the summary control.

In some embodiments, the displaying the summary of the second target section comprises: displaying the summary of the second target section in a panel above the reading interface of the second target section.

In some embodiments, the method further comprises: closing the summary of the second target section and displaying text of the second target section, in response to a closing operation on the summary of the second target section.

In some embodiments, the one or more distribution scenarios comprise a scenario of displaying a table of contents of the book, and the displaying the summary of the each of the sections in the one or more distribution scenarios in the reader, in response to the operation on the book comprises: displaying the table of contents of the book on the reader, and displaying abbreviated information of the summary of the each of the sections in the table of contents at a location corresponding to the each of the sections, in response to a trigger operation on the table of contents of the book; displaying the summary of a third target section, in response to a trigger operation to display the summary of the third target section among the sections.

In some embodiments, the abbreviated information of the summary of the each of the sections is obtained by truncating the summary of the each of the sections; or the abbreviated information of the summary of the each of the sections is generated using a generative model based on the summary of the each of the sections.

In some embodiments, the displaying the table of contents of the book on the reader, and displaying the abbreviated information of the summary of the each of the sections in the table of contents at the location corresponding to the each of the sections, in response to the trigger operation on the table of contents of the book comprises: displaying the table of contents of the book and displaying a switch control for the table of contents, in response to the trigger operation on the table of contents of the book; switching the table of contents between a first display state and a second display state, in response to a trigger operation on the switch control for the table of contents, wherein in the first display state, the abbreviated information of the summary of the each of the sections is displayed in the table of contents at the location corresponding to that section, and in the second display state, the abbreviated information of the summary of the each of the sections is hidden.

In some embodiments, the displaying the summary of the third target section, in response to the trigger operation to display the summary of the third target section among the sections comprises: displaying an expansion control at the location corresponding to the abbreviated information of the summary of the each of the sections, and displaying the summary of the third target section in response to a trigger operation on the expansion control corresponding to the third target section; or displaying the summary of the third target section, in response to a trigger operation in a display area of the abbreviated information of the summary of the third target section.

According to some embodiments of the present disclosure, there is provided an apparatus for displaying information of a book, comprising: a generation module configured to generate a summary for each of sections of the book based on content of the each of the sections; and a display module configured to display the summary of the each of the sections in one or more distribution scenarios in a reader, in response to an operation on the book, wherein the summary of the each of the sections is displayed in different forms in different distribution scenarios.

According to further embodiments of the present disclosure, there is provided an electronic device comprising: a memory; and a processor coupled to the memory, the processor configured to, based on instructions stored in the memory, carry out the method for displaying book information according to any one of the embodiments of the present disclosure.

According to still further embodiments of the present disclosure, there is provided a computer readable storage medium having stored thereon a computer program that, when executed by a processor, performs the method for displaying book information according to any one of the embodiments of the present disclosure.

According to further embodiments of the present disclosure, there is provided a computer program, comprising: instructions that, when executed by a processor, cause the processor to perform the method for displaying book information of any one of the embodiments of the present disclosure.

According to still further embodiments of the present disclosure, there is provided a computer program product comprising instructions that, when executed by a processor, implement the method for displaying book information according to any of the embodiments of the present disclosure.

The above description only shows some embodiments of the present disclosure and illustrates technical principles applied in the present disclosure. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

Many specific details are elaborated in the description of the present disclosure. However, it is understood that embodiments of the present invention can be implemented without these specific details. In other cases, well-known methods, structures, and techniques are not described in detail so as not to obscure the understanding of the description.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are comprised in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable subcombination.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

What is claimed is:

1. A method for displaying information of a book, comprising:
generating a summary for each of sections of the book based on content of the each of the sections; and
displaying the summary of the each of the sections in one or more distribution scenarios in a reader, in response to an operation on the book, wherein the summary of the each of the sections is displayed in different forms in different distribution scenarios.

2. The method for displaying the information of the book according to claim 1, wherein the generating the summary for the each of the sections of the book based on the content of the each of the sections comprises:
using a generative model to extract the content of the each of the sections, and generate the summary for the each of the sections of the book based on the content of the each of the sections.

3. The method for displaying the information of the book according to claim 1, further comprising:
generating a correlation graph based on the summary of the each of the sections in the book, wherein the correlation graph is used to represent relationships between key information in the sections, the key information comprising at least one of information of a role, information of a plot or information of a section; and
displaying correlation information based on the correlation graph, in response to a trigger operation on a correlation display function.

4. The method for displaying the information of the book according to claim 3, wherein the correlation display function comprises a correlation display function for displaying experience information of a target role, the correlation information comprising a path map of experiences of the target role, and the displaying the correlation information based on the correlation graph, in response to the trigger operation on the correlation display function comprises:
in response to the correlation display function for displaying the experience information of the target role being triggered, displaying the path map of experiences of the target role according to the correlation graph, wherein the path map of experiences comprises a plurality of nodes, each of the plurality of nodes corresponds to at least one of information of a key plot experienced by the target role or information of a section to which the key plot experienced by the target role belongs, and the information of the section to which the key plot experienced by the target role belongs comprises a summary of the section to which the key plot experienced by the target role belongs or an abbreviated summary generated based on the summary of the section to which the key plot experienced by the target role belongs.

5. The method for displaying the information of the book according to claim 3, wherein the correlation information comprises an outline structure diagram of the book, and the displaying the correlation information based on the correlation graph, in response to the trigger operation on the correlation display function comprises:
in response to the trigger operation on the correlation display function, displaying the outline structure diagram according to the correlation graph, wherein the outline structure diagram comprises multiple levels of nodes determined according to story development logic of the book, nodes in each level of the multiple levels corresponding to information of multiple plots and/or information of multiple sections, and the information of the multiple sections comprising summaries of the multiple sections or abbreviated summaries of the multiple sections generated based on the summaries of the multiple sections.

6. The method for displaying the information of the book according to claim 3, wherein the trigger operation on the correlation display function comprises an operation on related text or a correlation display control of target key information in a first target section among the sections, the correlation information comprising information related to the target key information, and the displaying the correlation information based on the correlation graph, in response to the trigger operation on the correlation display function comprises:
on a reading interface of the first target section, displaying the related text of the target key information in the first target section with a preset effect or displaying the correlation display control of the target key information in the first target section according to the correlation graph, wherein the target key information comprises a target role and/or a target plot; and
in response to the operation on the related text or the correlation display control of the target key information, displaying the information related to the target key information according to the correlation graph, wherein the information related to the target key information comprises at least one of information of a role related to the target key information, information of a plot related to the target key information or information of a section related to the target key information, the information of the section related to the target key information comprising a summary or an abbreviated summary generated based on the summary of the section related to the target key information.

7. The method for displaying the information of the book according to claim 6, wherein in response to the target key information comprising the target role:
the first target section is a section to which a key plot experienced by the target role belongs, and the information related to the target key information comprises at least one of information of a key plot experienced by the target role before the first target section and information of a section to which a key plot experienced by the target role before the first target section belongs; and/or
the first target section is a section to which a plot where a relationship between the target role and a first role who has a preset relationship with the target role changes belongs, the information related to the target key information comprising at least one of information of the first role, change information of the relationship between the target role and the first role, information of a plot where the relationship between the target role and the first role changes before the first target section, or information of a section to which the plot where the relationship between the target role and the first role belongs before the first target section changes.

8. The method for displaying the information of the book according to claim 6, wherein in response to the target key information comprising the target plot:
the information related to the target key information comprises at least one of information of a plot pointed to by the target plot or information of a section to which the plot pointed to by the target plot belongs; or
the target plot is a key plot experienced by a preset role, the information related to the target key information comprising at least one of information of one or more key plots experienced by the preset role before the target plot, or information of a section(s) to which the one or more key plots experienced by the preset role before the target plot belong; or
the target plot is a plot where a relationship between the preset role and a second role who has a preset relationship with the preset role changes, and the information related to the target key information comprises at least one of information of a plot where the relationship between the preset role and the second role changes before the target plot, or information of a section to which the plot where the relationship between the preset role and the second role changes before the target plot belongs; or
the target plot is a plot of a key node in story development, and the information related to the target key information comprises at least one of information of plots of multiple key nodes in the story development, information of sections to which the plots of the multiple key nodes in the story development belong, or a logical relationship between the multiple key nodes in the story development.

9. The method for displaying the information of the book according to claim 3, wherein the generating the correlation graph based on the summary of the each of the sections in the book comprises: for each role,
extracting experience information of the each role based on the summary of the each of the sections, wherein the experience information of the each role comprises information of a key plot experienced by the each role;
based on the experience information of the each role, determining a relationship between key information, wherein the relationship between the key information comprise at least one of a relationship between information of the each role and the information of the key plot experienced by the each role, a relationship between the information of the each role and information of a section to which the key plot experienced by the each role belongs, a relationship between the information of the key plot experienced by the each role and the information of the section to which the key plot experienced by the each role belongs, or a relationship between information of multiple key plots experienced by the role; and
generating the correlation graph based on the relationship between the key information.

10. The method for displaying the information of the book according to claim 3, wherein the generating the correlation graph based on the summary of the each of the sections in the book comprises:
based on the summary of the each of the sections, determining candidate sections comprising multiple roles from the sections;
determining relationships between the multiple roles in each of the candidate sections based on the summary of the each of the candidate sections;
determining the relationship between the key information based on the relationships between the multiple roles in each of the candidate sections, wherein the relationship between the key information comprises a relationship between information of the multiple roles; and
generating the correlation graph based on the relationship between the key information.

11. The method for displaying the information of the book according to claim 10, wherein the generating the correlation graph based on the summary of the each of the sections in the book further comprises:
for a role group of any multiple roles that have a relationship therebetween, determining change information of the relationship between the multiple roles in the role group and a plot where the relationship change based on a summary of a candidate section related to the role group;
based on the change information of the relationship between the multiple roles in the role group and the plot where the relationship change, determining the relationship between the key information, wherein the relationship between the key information comprises at least one of a relationship between information of the multiple roles in the role group, a relationship between the information of the multiple roles in the role group and information of the plot where the relationship change, a relationship between the information of the multiple roles in the role group and information of a section to which the plot where the relationship change belongs, a relationship between information of multiple plots where the relationship between the multiple roles changes, and a relationship between information of sections to which the multiple plots where the relationship between the multiple roles changes belong; and
generating the correlation graph based on the relationship between the key information.

12. The method for displaying the information of the book according to claim 3, wherein the generating the correlation graph based on the summary of the each of the sections in the book comprises:
based on the summary of each of the sections, determining logical information of a story of the book, wherein the logical information of the story comprises at least one of plot information of multiple key nodes in the story development and information of multiple plots with directional relationships;
based on the logical information of the story, determining the relationship between the key information, wherein in response to the logical information of the story comprising information of plots of multiple key nodes in story development, the relationship between the key information comprises at least one of a relationship between the information of the plots of the multiple key nodes or a relationship between information of sections to which the plots of multiple key nodes belong; in the case where the logical information of the story comprising information of multiple plots with directional relationships, the relationship between the key information comprises at least one of a relationship between information of the multiple plots with directional relationships or a relationship between information of sections to which the multiple plots with directional relationships belong; and
generating the correlation graph of the sections based on the relationship between the key information.

13. The method for displaying the information of the book according to claim 1, wherein the one or more distribution scenarios comprise a scenario of displaying a reading interface for the each of the sections, and the displaying the summary of the each of the sections in the one or more distribution scenarios in the reader, in response to the operation on the book comprises:
displaying a summary control in the reading interface of a second target section on the reader, in response to a reading operation on the second target section among the sections of the book; and
displaying the summary of the second target section, in response to a trigger operation on the summary control.

14. The method for displaying the information of the book according to claim 13, wherein:
the displaying the summary of the second target section comprises:
displaying the summary of the second target section in a panel above the reading interface of the second target section; and/or
the method for displaying the information of the book further comprising:
closing the summary of the second target section and displaying text of the second target section, in response to a closing operation on the summary of the second target section.

15. The method for displaying the information of the book according to claim 1, wherein the one or more distribution scenarios comprise a scenario of displaying a table of contents of the book, and the displaying the summary of the each of the sections in the one or more distribution scenarios in the reader, in response to the operation on the book comprises:
displaying the table of contents of the book on the reader, and displaying abbreviated information of the summary of the each of the sections in the table of contents at a location corresponding to the each of the sections, in response to a trigger operation on the table of contents of the book; and
displaying the summary of a third target section, in response to a trigger operation to display the summary of the third target section among the sections.

16. The method for displaying the information of the book according to claim 15, wherein:
the abbreviated information of the summary of the each of the sections is obtained by truncating the summary of the each of the sections; or
the abbreviated information of the summary of the each of the sections is generated using a generative model based on the summary of the each of the sections.

17. The method for displaying the information of the book according to claim 15, wherein the displaying the table of contents of the book on the reader, and displaying the abbreviated information of the summary of the each of the sections in the table of contents at the location corresponding to the each of the sections, in response to the trigger operation on the table of contents of the book comprises:
displaying the table of contents of the book and displaying a switch control for the table of contents, in response to the trigger operation on the table of contents of the book; and
switching the table of contents between a first display state and a second display state, in response to a trigger operation on the switch control for the table of contents, wherein in the first display state, the abbreviated information of the summary of the each of the sections is displayed in the table of contents at the location corresponding to that section, and in the second display state, the abbreviated information of the summary of the each of the sections is hidden.

18. The method for displaying the information of the book according to claim 15, wherein the displaying the summary of the third target section, in response to the trigger operation to display the summary of the third target section among the sections comprises:
displaying an expansion control at the location corresponding to the abbreviated information of the summary of the each of the sections, and displaying the summary of the third target section in response to a trigger operation on the expansion control corresponding to the third target section; or
displaying the summary of the third target section, in response to a trigger operation in a display area of the abbreviated information of the summary of the third target section.

19. An electronic device, comprising:
a processor; and
a memory coupled to the processor for storing instructions that, when executed by the processor, cause the processor to:
generate a summary for each of sections of a book based on content of the each of the sections; and
display the summary of the each of the sections in one or more distribution scenarios in a reader, in response to an operation on the book, wherein the summary of the each of the sections is displayed in different forms in different distribution scenarios.

20. A non-transitory computer-readable storage medium stored thereon a computer program that, when executed by a processor, causes the processor to:
generate a summary for each of sections of a book based on content of the each of the sections; and
display the summary of the each of the sections in one or more distribution scenarios in a reader, in response to an operation on the book, wherein the summary of the each of the sections is displayed in different forms in different distribution scenarios.
